(19) United States
(12) Patent Application Publication
(10) Pub. No.: US 2009/0093231 A1
(43) Pub. Date: Apr. 9, 2009

(54) METHOD, SYSTEM AND DEVICE FOR CHARGING IN PoC SYSTEM

(75) Inventor: Dong ZHAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/331,091

(22) Filed: Dec. 9, 2008

Related U.S. Application Data
(63) Continuation of application No. PCT/CN2007/070088, filed on Jun. 6, 2007.

(30) Foreign Application Priority Data
Jun. 22, 2006 (CN) 200610090042.4

(51) Int. Cl. H04W 4/24

(52) U.S. Cl. 455/406

(57) ABSTRACT

Embodiments of the present invention disclose a charging method in Push to talk over Cellular (PoC) system. The method includes receiving, by a charging function, a charging request from a PoC server, wherein the charging request includes user access priority information; resolving, by a charging function (CF), the charging request to acquire the user access priority information; and performing, upon the PoC server, a charging policy associated with the user access priority according to the user access priority information. Embodiments of the present invention also disclose a charging system in PoC system, a PoC server and a charging function (CF). By applying the present invention, different charging policies are applied to different user based on the differentiation of user access priority. Therefore, the charging is more accurate and the present invention is also convenient to apply.

### CROSS-REFERENCE TO RELATED APPLICATIONS

This application is a continuation of International Patent Application No. PCT/CN2007/070088, filed Jun. 6, 2007, which claims priority to Chinese Patent Application No. 200610090042.4, filed Jun. 22, 2006, both of which are hereby incorporated by reference in their entirety.

### FIELD OF THE INVENTION

The present invention relates to Push to talk over Cellular (PoC) technology, and, more particularly, to a charging method, charging system, and charging device in PoC system.

### BACKGROUND

Push to talk over Cellular (PoC) service is a cluster media communication service based on Internet Protocol (IP) technology. The PoC service is implemented via half-duplex VoIP technology on a carrier network. A PoC user can communicate with other PoC users through point-to-point or multipoint-to-multipoint half-duplex call after the PoC user has set a group list. To build a PoC service based on existing Global System for Mobile Communication (GSM)/General Packet Radio Service (GPRS) can accomplish quick start of the service and reduced expense on investment, the service also can naturally evolve into 3rd Generation Mobile Communication (3G).

FIG. 1 is a schematic overview of an existing PoC service. As shown in FIG. 1, each PoC user can communicate with other PoC users through point-to-point or multipoint-to-multipoint half-duplex call via a wireless network.

An existing PoC system typically includes a PoC system internal logic entity and an external entity.

FIG. 2 is a schematic diagram of the structure of the existing PoC service. As shown in FIG. 2, the PoC system internal logic entity includes a PoC client, a PoC server, and a plurality of PoC enablers, such as Security enabler, Charging enabler, etc. The enablers only interact with a corresponding PoC server. The PoC server performs main functions of PoC, and the PoC client operates via the PoC server. The PoC server includes Controlling PoC Function (CPF) and Participating PoC Function (PPF).

FIG. 3 illustrates the relationship between the entities in PoC communication in the prior art. As shown in FIG. 3, CPF is the core of communication and carries out a centralized control. The CPF performs functions, such as session control (session setup/cancellation, signaling and media negotiation, request processing, and communication control, such as media streams distribution), group strategy implementation (including collecting and controlling QoS), and user interface adaption. Each PoC client corresponds to a PPF, each PPF session operation sends a request to the CPF, and the CPF coordinates and controls the process of the session (such as media distribution, data transmission, right and role transition, and QoS authentication, etc.). For communications between PoC clients that join the session, the PPF requests CPF for CPF instructions and receives the CPF instructions. The CPF then distributes media and data to the PPF, according to a policy. Each PPF then forwards the media and data to the PoC client that is connected correspondingly, and the point-to-point or point-to-multipoint communications between PoC clients are accomplished.

The CPF and PPF are functional modules. They may locate on a same PoC server, or belong to different PoC servers and perform different functions. A PoC client is the functional entity which the PoC user utilizes to join the session. The role of PoC client is one of the attributes of the PoC user. The PoC users can form a PoC group.

In the prior art, during PoC charging, the PPF and CPF are distinguished. The difference can be distinguished by PoC-Server-role field in PoC-information structure.

However, except for the difference between the PPF and CPF, PoC users themselves shall be distinctive regarding the PoC service. For a PoC session, in terms of service transmission, resource reservation, or session operation, etc, some events, such as lack of resource, conflict of requests, or change of occupied resources due to emergent incidents, may occur. Thus, a mechanism is needed for determining the order for processing user requests, and the difference in processing order shall be reflected in the charging policy; otherwise, the charging will be inaccurate.

However, existing charging mechanisms do not distinguish PoC users, nor perform different charging policies for different PoC users. Therefore, the existing charging mechanism is inaccurate.

### SUMMARY

Accordingly, a main purpose of embodiments of the present invention is to present a charging method in PoC system that performs different charging policies for different users, so as to accomplish accurate charging.

Another purpose of embodiments of the present invention is to present a charging system in PoC system that performs different charging policies for different users, so as to accomplish accurate charging.

Another purpose of embodiments of the present invention is to present a PoC server that performs different charging policies for different users, so as to accomplish accurate charging.

Another purpose of embodiments of the present invention is to present a Charging Function (CF) that performs different charging policies for different users, so as to accomplish accurate charging.

To achieve the above objects, embodiments of the present invention provide solutions as follows.

A charging method in PoC system according to the embodiments of the present invention includes:

receiving, by a charging function, a charging request from a PoC server, wherein the charging request includes user access priority information; and

resolving, by a charging function (CF), the charging request to acquire the user access priority information, and performing, upon the PoC server, a charging policy associated with the user access priority according to the user access priority information.

A charging system in PoC system according to the embodiments of the present invention includes a PoC server and a Charging Function (CF), wherein:

the PoC server is configured to send a charging request to the CF, wherein the charging request includes user access priority information; and

the CF is configured to resolve the charging request to acquire the user access priority information, and perform, upon the PoC server, a charging policy associated with the user access priority according to the user access priority information.

A PoC server according to the embodiments of the present invention includes a charging request setting unit and a charging request sending unit, wherein:

the charging request setting unit is configured to generate a charging request that includes user access priority information; and

the charging request sending unit is configured to send the charging request generated by the charging request setting unit to a Charging Function (CF).

A Charging Function (CF) according to the embodiments of the present invention includes a charging request receiving unit, a charging request resolving unit and a charging policy performing unit, wherein:

the charging request receiving unit is configured to acquire the charging request from the PoC server, wherein the charging request includes user access priority information;

the charging request resolving unit is configured to resolve the charging request to acquire the user access priority information; and

the charging policy performing unit is configured to perform, upon the PoC server, a charging policy associated with the user access priority, according to the user access priority information.

It can be seen from the above solutions that, according to embodiments of the present invention, a CF receives a charging request sent by a PoC server, and the charging request includes user access priority information. The CF resolves the charging request to acquire the user access priority information and performs, upon the PoC server, a charging policy associated with the user access priority according to the user access priority information. In embodiments of the present invention, because the charging request sent by the PoC server includes user access priority information, the CF can resolve and acquire user access priority information, and further perform a charging policy associated with the user access priority, according to the user access priority information upon the PoC server. Therefore, embodiments of the present invention perform different charging policies to different uses by differentiating the user access priority, and thereby achieve a more accurate charging.

### BRIEF DESCRIPTION OF THE DRAWINGS

FIG. 1 is a schematic overview of an existing PoC service;

FIG. 2 is a schematic diagram of the structure of an existing PoC system;

FIG. 3 illustrates the relationship among entities of PoC communication;

FIG. 4 is a schematic diagram of an exemplary flow of a charging method in PoC system, according to an embodiment of the present invention;

FIG. 5 is a schematic diagram of an exemplary flow of an off-line charging method, according to an embodiment of the present invention;

FIG. 6 is a schematic diagram of an exemplary flow of an on-line charging method, according to an embodiment of the present invention;

FIG. 7 is a schematic diagram of an exemplary structure of a charging system, according to an embodiment of the present invention;

FIG. 8 is a schematic diagram of an exemplary structure of a PoC server, according to an embodiment of the present invention; and

FIG. 9 is a schematic diagram of an exemplary structure of a Charging Function (CF), according to an embodiment of the present invention.

### DETAILED DESCRIPTION

The purposes, solutions and advantages of the present invention will be more apparent through the following detailed descriptions of the embodiments of the present invention, in conjunction with the accompanying drawings.

The main ideas of embodiments of the present invention is that a PoC server sends, to a Charging Function (CF), a charging request that includes user access priority information. The CF resolves the charging request to acquire the user access priority information and performs, upon the PoC server, a charging policy associated with the user access priority, according to the user access priority information.

PoC user access priority is a differentiated priority when creating/participating a PoC session; the access priority will affect the differentiation of other priorities. PoC user access priority can be configured on XDMS or other user devices. In PoC charging of the present invention, access priorities are distinguished for different users so as to reflect the priority right of the user in PoC service. For example, the users can be divided into 5 levels, as shown in Table 1. The priority is decreased in order from Level 1 to Level 5. Table 1 is an exemplary table of differentiated priority for PoC users.

TABLE 1

| | |
|---|---|
| Level 1 | Leader, Policy Executor level |
| Level 2 | Disaster/Military Control level |
| Level 3 | Public Health, Security, and Right Execution |
| | Department level |
| Level 4 | Public Service/Public Welfare level |
| Level 5 | Disaster Recovery level |

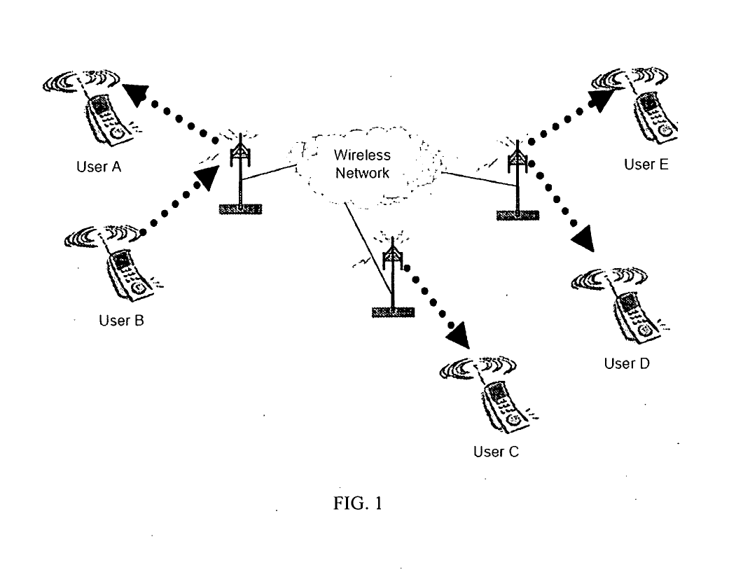

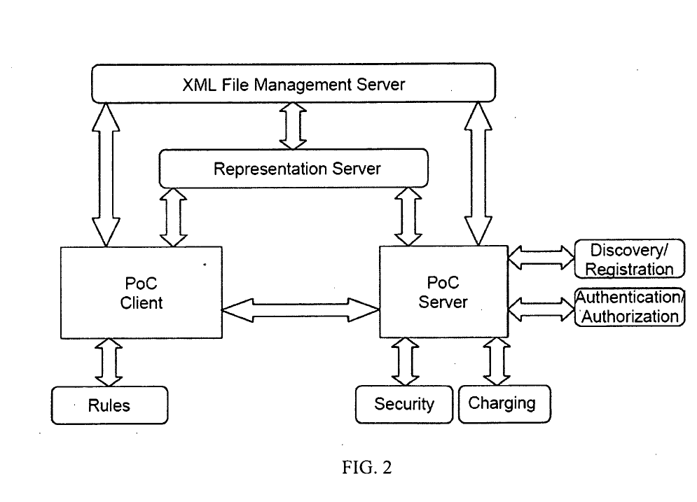

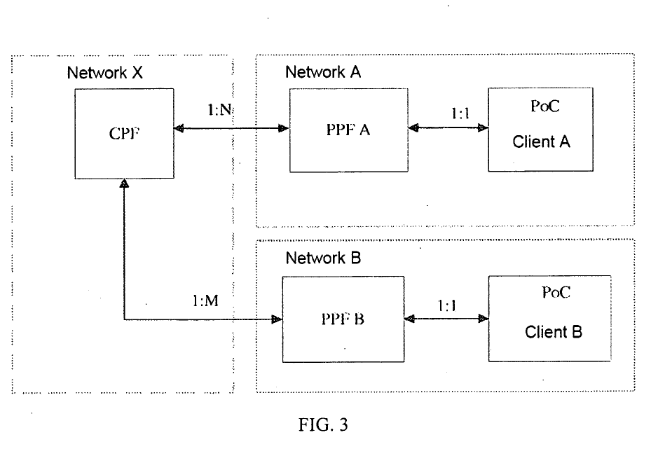

It is obvious that the differentiation of PoC users shown in FIG. 1 is exemplary and is not intended to limit the scope of the present invention. Actually, based on different concrete application circumstance and requirements, distinction of access priority for PoC users may have a plurality of types, such content is not described in detail herein.

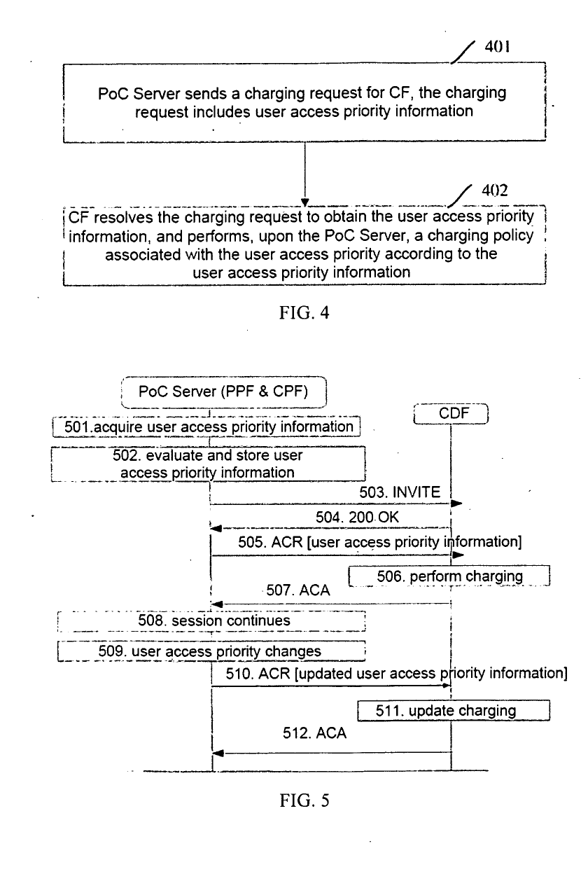

FIG. 4 is a schematic diagram of an exemplary flow of a charging method in a PoC system, according to an embodiment of the present invention. As shown in FIG. 4, the method includes the following steps.

Step 401: A PoC server sends a charging request to a Charging Function (CF). The charging request includes user access priority information.

Step 402: The CF resolves the charging request to acquire the user access priority information, and the CF also performs, upon the PoC server, a charging policy associated with the user access priority, according to the user access priority information.

After distinguishing the user access priority, the charging request sent by the PoC server to the CF includes the user access priority information. The CF can perform a corresponding charging policy after resolving the user access priority information.

Due to many circumstances, when a user creates/participates a PoC session, a request related to user access priority will be triggered, and the request carries user access priority information. After receiving the request, the PoC server acquires detailed priority parameters by preferably utilizing information associated with user access priority (such as user ID, priority ID, etc.), and evaluates the priority parameters in connection with current operation parameters and operation environment. The evaluation process may involve billing, security and contracting, etc.

In the present embodiment, preferably before Step 401, the method further includes the following. The PoC server receives a request associated with user access priority, and the request includes user access priority information. The PoC server performs a session rule evaluation for the user access priority information, and if the user access priority information complies with the session rule, Step 401 is performed. The session rule includes any one of billing rule, security rule, and user subscripting rule, or a combination thereof.

The request associated with user access priority is preferably to be:

a request sent from a PoC user to the PoC server, associated with user access priority; or

a request sent from an external extended service to the PoC server, associated with user access priority; or

a request triggered by a special user modifying a low access priority of a user to a high access priority, associated with user access priority; or

a request triggered by the PoC server modifying an access priority predetermined by a user, associated with user access priority.

The charging method mentioned herein can be applied to off-line charging and on-line charging.

When applying embodiments of the present invention to off-line charging, the CF in Step 401 is Charging Data Function (CDF). The PoC server sends an off-line charging request to the CDF; the CDF resolves the off-line charging request to acquire the user access priority information and performs, upon the PoC server, an off-line charging policy associated with the user access priority, according to the user access priority information.

When applying embodiments of the present invention to on-line charging, the CF in step 401 is Online Charging System (OCS). The PoC server sends an on-line charging request to the OCS; the OCS resolves the on-line charging request to acquire the user access priority information and performs, upon the PoC server, an on-line charging policy associated with the user access priority, according to the user access priority information.

Preferably, when user access priority changes, off-line charging policy shall be performed based on the modified user access priority, charging data shall also be updated.

When applying embodiments of the present invention to off-line charging, if user access priority changes, the PoC server sends an off-line charging updating request to the CDF. The off-line charging updating request includes the modified user access priority information. The CDF resolves the off-line charging updating request to acquire the modified user access priority information and performs, upon the PoC server, an off-line charging policy associated with the modified user access priority, according to the modified user access priority information.

When applying embodiments of the present invention to on-line charging, if user access priority changes, the PoC server sends an on-line charging updating request to the OCS, the on-line charging updating request includes the modified user access priority information. The OCS resolves the on-line charging updating request to acquire the modified user access priority information and performs, upon the PoC server, an on-line charging policy associated with the modified user access priority according to the modified user access priority information.

Description of user access priority information can be added into existing PoC-Information structure. For example, it is preferably to add a PoC-User-Access-Priority field in the existing PoC-Information structure to indicate user access priority information parameters. The PoC-User-Access-Priority field can include a plurality of nulls, which belongs to DataSet type structure. Table 2 is an illustrative table of adding the PoC-User-Access-Priority field into the PoC-Information structure, wherein the “PoC-User-Access-Priority” is the newly added field.

TABLE 2

| Field | Function |
|---|---|
| PoC-Server-Role | |
| PoC-User-Access-Priority | This field indicates the structure |
| | of user access priority information |
| | parameters. Such structure can |
| | include a plurality of nulls, |
| | which belong to DataSet type |
| | structure. |
| PoC-Session-Type | |
| Number-Of-Participants | |
| List-Of-Participants | |
| List-Of-Talk-Burst-Exchange | |
| PoC-Controlling-Address | |
| PoC-Group-Name | |
| PoC-Session-Id | |

Adding a PoC-User-Access-Priority field in a PoC-Information is described above in detail. However, one of the ordinary skilled in the art may realize that this is just an exemplary example and is not intended to limit the scope of the present invention. Actually, a corresponding field can also be added into other available structures so as to describe user access priority information.

PoC-User-Access-Priority is a DataSet type data and may include the following information fields: access priority ID, which can be set as an Unsigned32 type; access priority expiration period, which can be set as a TIME type; access priority description, which can be set as a UTF8String type; and access priority revisability, which can be set as a Boolean type.

A more detailed description of an exemplary embodiment of the present invention will be introduced below.

FIG. 5 is an exemplary flowchart of an off-line charging method, according to an embodiment of the present invention. As shown in FIG. 5, the method includes the following steps.

Step 501: A PoC server receives a request associated with user access priority. The request includes user access priority information.

When a user creates/participates a session, many circumstances may trigger a request associated with user access priority. The circumstances include: a user with access priority configuration sends a request carrying access priority information when creating/participating a session so as to enable the PoC server to determine the processing order when a request conflict occurs; or, an External service sends, to the PoC server, a request carrying access priority information when creating/participating a session or participating modification of session control; or, the PoC server modifies, based on current operation policy, access priority attribute that is previously configured by a user, and the result of the modification is reflected in a current session or a session to be created. Furthermore, the circumstance may be a request triggered by a special user modifying a user with low access priority to a user with high access priority.

Step 502: The PoC server performs a session rule evaluation for the user access priority information and stores the user access priority information.

Here, after the PoC server has received the request associated with user access priority, the PoC server acquires detailed priority parameters by utilizing information associated with user access priority (such as user ID, priority ID, etc.), and evaluates the priority parameters in connection with current operation parameters and operation environment. Correspondingly, the session rule may involve any one of billing rule, security rule, user contracting rule, or a combination thereof.

Steps 503-504: The PoC server sends an INVITE request to a CDF, and the CDF returns 200 OK response to the PoC server.

Steps 505-507: The PoC server initiates an off-line charging request ACR. The off-line charging request carries user access priority information. The CDF performs charging to the user based on the user access priority information, and returns an off-line charging acknowledgement ACA to the PoC server.

Step 508: The session continues.

Up to now, PoC off-line charging process is completed. When user access priority information changes during a session, a charging updating event will be triggered.

Steps 509-512: When user access priority changes, the PoC server sends an off-line charging updating request to the CDF, wherein the off-line charging updating request includes the modified user access priority information. The CDF resolves the off-line charging updating request to acquire the modified user access priority information and performs, upon the PoC server, an off-line charging policy associated with the modified user access priority, according to the modified user access priority information.

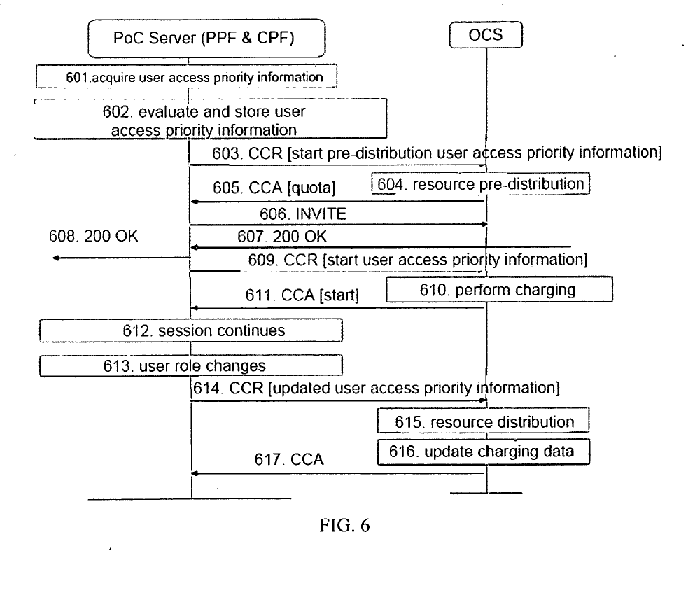

FIG. 6 is a schematic diagram of an exemplary flow of an on-line charging method, according to an embodiment of the present invention. As shown in FIG. 6, the method includes the following steps.

Step 601: A PoC server receives a request associated with user access priority wherein the request includes user access priority information.

When a user creates/participates a session, many circumstances may trigger a request associated with user access priority. The circumstances include: a user with access priority configuration sends a request carrying access priority information when creating/participating a session so as to enable the PoC server to determine the processing order when a request conflict occurs; or, an external service sends, to the PoC server, a request carrying access priority information when creating/participating a session or participating modification of session control; or, the PoC server modifies, based on current operation policy, access priority attribute that is previously configured by a user, and the result of the modification is reflected in a current session or a session to be built. Furthermore, the circumstance may be a request triggered by a special user modifying a user with low access priority to a user with high access priority.

Step 602: The PoC server performs a session rule evaluation for the user access priority information and stores the user access priority information.

Here, after receiving the request associated with user access priority, the PoC server acquires detailed priority parameters by utilizing information associated with user access priority (such as user ID, priority ID, etc.), and evaluates the priority parameters in connection with current operation parameters and operation environment. Correspondingly, the session rule may involve any one of billing rule, security rule, user contracting rule, or a combination thereof.

Step 603: When the session rule is complied, the PoC server sends an on-line charging request (OCR) to an OCS to initiate a resource pre-distribution. The on-line charging request includes user access priority information.

Step 604: The OCS performs resource pre-distribution. For on-line charging, after the request associated with user access priority is received, it is needed to perform resource pre-distribution on the OCS. If the pre-distribution is successful, the request associated with user access priority is acceptable and a subsequent process is performed. If the pre-distribution fails, it means lack of resource and the access request associated with this user access priority cannot be performed.

Step 605: The OCS returns a charging acknowledgement CCA to the PoC server, wherein the CCA includes quota information.

Step 606: The PoC server sends an INVITE request to the OCS.

Steps 607-608: The OCS returns a 200 OK information to the PoC server. The PoC server returns the 200 OK message to the initiator of the user access request.

Steps 609-611: After having successfully pre-distributed the resource, the PoC server accepts the access request of the user and performs a corresponding on-line charging policy upon the access. The on-line charging policy may include rate selection, data recording of generating the access event, etc.

Step 612: The session continues.

Up to now, on-line charging process is completed. When user access priority information changes during a session, a charging updating event will be triggered.

Steps 613-617: When user access priority changes, the PoC server sends an on-line charging updating request to the OCS. The on-line charging updating request includes the modified user access priority information. The OCS resolves the on-line charging updating request to acquire the modified user access priority information and performs, upon the PoC server, an on-line charging policy associated with the modified user access priority, according to the modified user access priority information. The OCS also updates current distribution of resource and current charging data, based on the status of the occupied resource in the request.

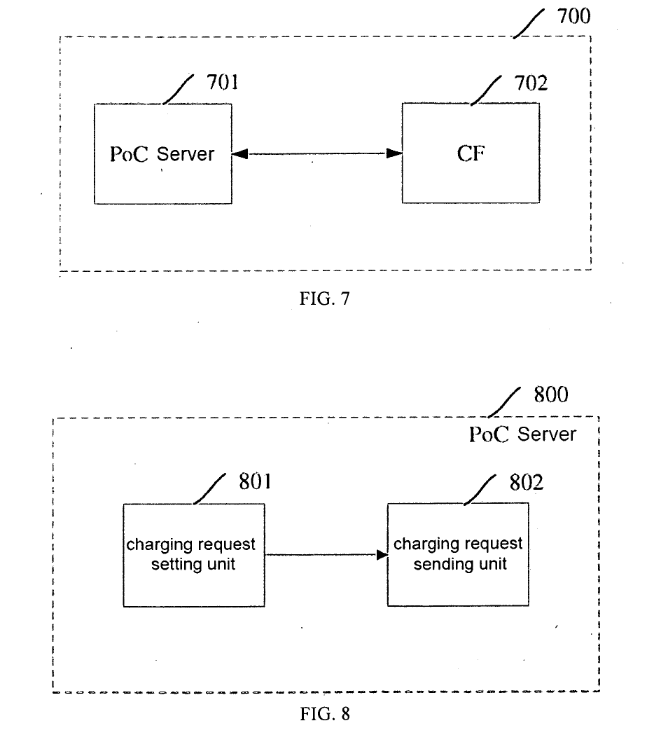

Embodiments of the present inventions also disclose a charging system in PoC system. FIG. 7 is a schematic diagram of an exemplary structure of a charging system, according to an embodiment of the present invention.

As shown in FIG. 7, the system 700 includes a PoC server 701 and a Charging Function (CF) 702.

The PoC server 701 is configured to send a charging request to the Charging Function (CF) 702. The charging request includes user access priority information.

The CF 702 is configured to resolve the charging request to acquire the user access priority information, and perform, upon the PoC server 701, a charging policy associated with the user access priority, according to the user access priority information.

The CF can be a Charging Data Function (CDF), and the charging request can be an off-line charging request. The CDF is configured to perform, upon the PoC server, an off-line charging policy associated with the user access priority.

Additionally, when user access priority changes, the PoC server 701 sends an off-line charging updating request to the CDF. The off-line charging updating request includes the modified user access priority information.

The CDF resolves the off-line charging updating request to acquire the modified user access priority information and performs, upon the PoC server, an off-line charging policy associated with the modified user access priority, according to the modified user access priority information.

The CF can be an Online Charging System (OCS), and the charging request can be an on-line charging request. The OCS is configured to perform, upon the PoC server, an on-line charging policy associated with the user access priority.

When user access priority changes, the PoC server sends an on-line charging updating request to the OCS. The on-line charging updating request includes the modified user access priority information.

The OCS resolves the on-line charging updating request to acquire the modified user access priority information and performs, upon the PoC server, an on-line charging policy associated with the modified user access priority, according to the modified user access priority information.

Embodiments of the present invention also disclose a PoC server.

FIG. 8 is a schematic diagram of an exemplary structure of a PoC server, according to an embodiment of the present invention.

As shown in FIG. 8, the PoC server includes a charging request setting unit 801 and a charging request sending unit 802.

The charging request setting unit 801 is configured to generate a charging request that includes user access priority information.

The charging request sending unit 802 is configured to send the charging request generated by the charging request setting unit to the Charging Function (CF).

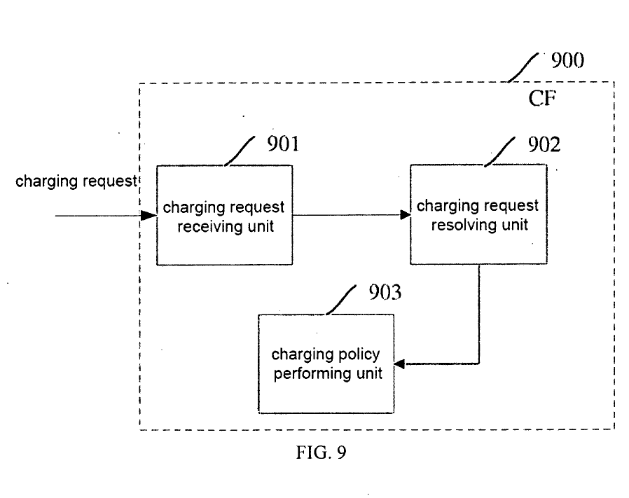

Embodiments of the present invention also disclose a Charging Function. FIG. 9 is a schematic diagram of an exemplary structure of a Charging Function, according to an embodiment of the present invention.

As shown in FIG. 9, the CF includes a charging request receiving unit 901, a charging request resolving unit 902, and a charging policy performing unit 903.

The charging request receiving unit 901 is configured to acquire the charging request from the PoC server, and the charging request includes user access priority information.

The charging request resolving unit 902 is configured to resolve the charging request to acquire the user access priority information.

The charging policy performing unit 903 is configured to perform, upon the PoC server, a charging policy associated with the user access priority, according to the user access priority information.

Summing up, embodiments of the present invention, based on access priority, collect and process detailed information about changes in user access priority from which the operators can extract necessary data for charging or billing so as to perform different charging methods for providing different services.

Embodiments of the present invention are able to monitor trigger events with different access priorities and reporting to the upper system by amending only a few fields, it is very convenient to apply the present invention.

The above embodiments are merely used to illustrate the present invention but not to limit the present invention. Any modification, equivalent substitution, or improvement within the principal and spirit of the present invention shall be regarded as within the scope of the present invention.

What is claimed is:

1. A charging method in Push to talk over Cellular, PoC, system, comprising:
receiving, by a charging function, CF, a charging request from a PoC server, wherein the charging request comprises user access priority information; and
resolving, by the CF, the charging request to acquire the user access priority information, and performing, upon the PoC server, a charging policy associated with the user access priority, according to the user access priority information.

2. The charging method in PoC system of claim 1, further comprising:
receiving, by the PoC server, a request associated with user access priority, wherein the request associated with user access priority comprises user access priority information; and
performing, by the PoC server, a session rule evaluation for the user access priority information, and sending the charging request to the charging function if the session rule is complied.

3. The charging method in PoC system of claim 2, wherein the session rule comprises any one of billing rule, security rule, and user contracting rule, or a combination thereof.

4. The charging method in PoC system of claim 2, wherein:
the request associated with user access priority comprises one of:
a request which is sent from a PoC user to the PoC server and which is associated with user access priority;
a request which is sent from an external service to the PoC server and which is associated with user access priority;
a request which is triggered by a special user modifying a user with low access priority to a user with high access priority and which is associated with user access priority; and
a request which is triggered by the PoC modifying a predetermined access priority of a user and which is associated with user access priority.

5. The charging method in PoC system of claim 1, wherein:
the CF is a Charging Data Function, CDF, and the charging request is an off-line charging request; and
the charging policy performed by the CF upon the PoC server is an off-line charging policy associated with the user access priority, performed by the CDF upon the PoC server.

6. The charging method in PoC system of claim 2, wherein:
the CF is a Charging Data Function, CDF, and the charging request is an off-line charging request; and
the charging policy performed by the CF upon the PoC server is an off-line charging policy associated with the user access priority, performed by the CDF upon the PoC server.

7. The charging method in PoC system of claim 3, wherein:
the CF is a Charging Data Function, CDF, and the charging request is an off-line charging request; and
the charging policy performed by the CF upon the PoC server is an off-line charging policy associated with the user access priority, performed by the CDF upon the PoC server.

8. The charging method in PoC system of claim 4, wherein:
the CF is a Charging Data Function, CDF, and the charging request is an off-line charging request; and
the charging policy performed by the CF upon the PoC server is an off-line charging policy associated with the user access priority, performed by the CDF upon the PoC server.

9. The charging method in PoC system of claim 1, wherein:
the CF is Online Charging System, OCS, and the charging request is an on-line charging request; and
the charging policy performed by the CF upon the PoC server is an on-line charging policy associated with the user access priority, performed by the OCS upon the PoC server.

10. The charging method in PoC system of claim 2, wherein:
the CF is Online Charging System, OCS, and the charging request is an on-line charging request; and
the charging policy performed by the CF upon the PoC server is an on-line charging policy associated with the user access priority, performed by the OCS upon the PoC server.

11. The charging method in PoC system of claim 3, wherein:
the CF is Online Charging System, OCS, and the charging request is an on-line charging request; and
the charging policy performed by the CF upon the PoC server is an on-line charging policy associated with the user access priority, performed by the OCS upon the PoC server.

12. The charging method in PoC system of claim 4, wherein:
the CF is Online Charging System, OCS, and the charging request is an on-line charging request; and
the charging policy performed by the CF upon the PoC server is an on-line charging policy associated with the user access priority, performed by the OCS upon the PoC server.

13. The charging method in PoC system of claim 5, further comprising:
receiving, by the CDF, an off-line charging updating request sent by the PoC server when user access priority changes, wherein the off-line charging updating request comprises modified user access priority information;
resolving, by the CDF, the off-line charging updating request to acquire the modified user access priority information, and performing, upon the PoC server, an off-line charging policy associated with the modified user access priority according to the modified user access priority information.

14. The charging method in PoC system of claim 9, further comprising:
performing, by the PoC server, resource pre-distribution on the OCS, and sending the charging request to the charging function when the resource pre-distribution is successful.

15. The charging method in PoC system of claim 14, further comprising:
sending, by the PoC server, an on-line charging updating request to the OCS when user access priority changes, wherein the on-line charging updating request comprises modified user access priority information; and
resolving, by the OCS, the on-line charging updating request to acquire the modified user access priority information, and performing, upon the PoC server, an on-line charging policy associated with the modified user access priority, according to the modified user access priority information.

16. The charging method in PoC system of claim 1, wherein the charging request comprises a field indicating user access priority information.

17. The charging method in PoC system of claim 16, wherein the field indicating user access priority information comprises any one of an access priority ID information field, an access priority expiration information field, an access priority description information field, or an access priority revisability information field, or a combination thereof.

18. A charging system in Push to talk over Cellular, PoC, system, comprising a PoC server and a charging function, CF, wherein:
the PoC server is configured to send a charging request to the CF, wherein the charging request includes user access priority information; and
the CF is configured to resolve the charging request to acquire the user access priority information, and perform, upon the PoC server, a charging policy associated with the user access priority, according to the user access priority information.

19. The charging system in PoC system of claim 18, wherein:
the CF is Charging Data Function, CDF, and the charging request is an off-line charging request; and
the charging policy performed by the CF upon the PoC server is an off-line charging policy associated with the user access priority, performed by the CDF upon the PoC server.

20. The system of claim 18, wherein:
the CF is Online Charging System, OCS, and the charging request is an on-line charging request; and
the charging policy performed by the CF upon the PoC server is an on-line charging policy associated with the user access priority, performed by the OCS upon the PoC server.

21. A Push to talk over Cellular, PoC, server, comprising a charging request setting unit and a charging request sending unit, wherein:
the charging request setting unit is configured to generate a charging request that includes user access priority information; and
the charging request sending unit is configured to send the charging request generated by the charging request setting unit to a charging function, CF.

22. A charging function, CF, comprising a charging request receiving unit, a charging request resolving unit and a charging policy performing unit, wherein:
the charging request receiving unit is configured to acquire the charging request from the PoC server, and the charging request includes user access priority information;
the charging request resolving unit is configured to resolve the charging request to acquire the user access priority information; and
the charging policy performing unit is configured to perform, upon the PoC server, a charging policy associated with the user access priority according to the user access priority information.
